(19) United States
(12) Patent Application Publication
(10) Pub. No.: US 2019/0121046 A1
(43) Pub. Date: Apr. 25, 2019

(54) METHOD OF SECURING FIBER OPTIC CASSETTES ALLOWING FOR TOOL-LESS INSERTION AND EXTRACTION

(71) Applicant: Indania Corporation, Medway, MA (US)

(72) Inventor: Steven Rolfe, Seekonk, MA (US)

(21) Appl. No.: 15/910,649

(22) Filed: Mar. 2, 2018

Related U.S. Application Data
(60) Provisional application No. 62/467,007, filed on Mar. 3, 2017.

(51) Int. Cl. G02B 6/44

(52) U.S. Cl. CPC G02B 6/4453

(57) ABSTRACT

Spring retainer units or clips according to the present invention are configured to be secured to the desired surface using the mounting holes provided with screws, rivets, or other fasteners. The spring retainer units or clips include a protrusion on one or more sides of the clip which meets and releasably interconnects with an opening in each the side of the cassette. Two spring retainer units or clips are required for each cassette, one for each side.

### CROSS-REFERENCE TO RELATED APPLICATIONS

This application claims priority from U.S. Provisional Patent Application No. 62/467,007 titled “METHOD OF SECURING FIBER OPTIC CASSETTES ALLOWONG FOR TOOL LESS INSERTION AND EXTRACTION” filed on Mar. 3, 2017 and which is incorporated fully herein by reference.

### FIELD OF THE INVENTION

The present invention relates to fiber optic wire connector cassettes and more particularly, to a spring clip designed to snap into a square shaped cavity in the side of a cassette when the cassette slides against a protrusion provided in the spring clip.

### BACKGROUND OF THE INVENTION

There exists a need for a securing system for a fiber optic cassette as commonly used in data centers and other facilities that can be rapidly inserted and removed without the use of tools, fasteners or the need to try to fit adult sized fingers and thumbs into or cramped quarters.

There are many ways to secure fiber optic cassettes to a rack or mount on the market, there is a lack of securing methods that are user friendly and ergonomic.

Currently, systems offered on the market are secure and robust, but require tools and/or time to install, remove, or swap out the cassette from the mount.

This present invention features a product design that allows for both standard and non-standard installation of a fiber optic cassette in a rack or other mount that has been designed and manufactured to accommodate and solve for the identified issues as listed above.

### SUMMARY OF THE PREFERRED EMBODIMENT

The spring retainer units or clips according to the present invention employ a design that allows one to simply grasp the front of a cassette manufactured with a square or rectangular side wall cavity and simply pull it out, or slide it in to a rack or similar mount while maintaining a secure, latched solution.

The spring clips may be made of plastic such as ABS or PLA or spring metal.

The spring clips are not restricted to use in a standard rack or case, and can in fact be fastened to any flat surface such as a shelf, wall, ceiling, under desks, etc.

The present invention features a spring clip that is specifically designed to snap into a square shaped cavity when the side of a cassette slides against the protrusion until engagement is made. The clip according to the present invention allows one to simply grasp the front of the cassette and simply pull it out, or slide it in while maintaining a secure, latched solution.

The material used maybe ABS (3D printed, or molded), or a spring metal which is stamped and bent. Regardless of the material selected, the design demands it act as a spring with an angled or curved protrusion that engages into a cavity on the side of a cassette.

The several features of the spring clip according to the present invention include (but are not limited to):
1. a body of the spring engagement unit/clip.
2. mounting holes to secure spring clip to a desired surface such as a flat surface or the surface of a mounting rack such as an electronic equipment rack.
3. a spring tension lever with a clearance above the bottom of the body of the cassette to assure unimpeded movement of the cassette in and out of the mounting position.
4. a protrusion in at least one leg of the spring clip to engage into a rectangular or square cavity present on the side of the cassette.

The present invention features a retainer device configured for being secured to a surface and including a first side and a second side. The second side being a mirror-image of the first side. The first and second sides each have a predetermined length. The second side is coupled a spaced distance apart from the first side by a connector element which extends between the first and second side a length which is less than the predetermined length of the first and second sides. Each of the first and second sides include a first end and a second end. The second end of each of the first and second sides of the retainer device includes an arcuately shaped protrusion configured for releasably engaging with an opening in a device to be releasably secured to the surface.

It is important to note that the present invention is not intended to be limited to a device or method which must satisfy one or more of any stated or implied objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the allowed claims.

### BRIEF DESCRIPTION OF THE DRAWINGS

These and other features and advantages of the present invention will be better understood by reading the following detailed description, taken together with the drawings wherein:

FIGS. 1A and 1B are perspective plan views of one embodiment of the spring clip according to the present invention;

FIGS. 2A-2B are perspective top views of one embodiment of the spring clip according to the present invention; and

FIGS. 3A-3F are perspective plan views of the universal latch recess on a fiber-optic cassette utilized to secure the cassette with a variety of latches and spring clips according to the present invention.

### DETAILED DESCRIPTION OF THE PREFERRED EMBODIMENTS

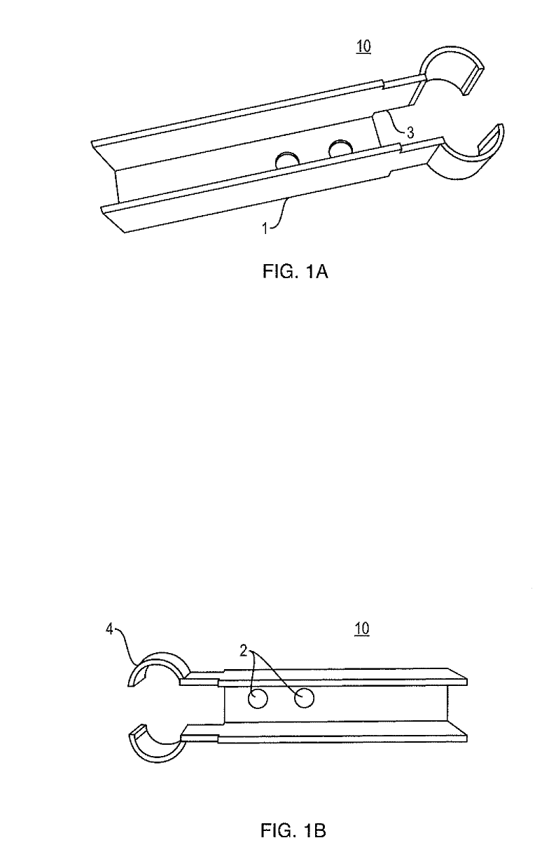

The spring clips 10, FIG. 1A according to the present invention are, in one embodiment, designed and configured to be secured to a desired surface (not shown) such as a mounting rack for electronic devices or a flat surface using the mounting holes 2 utilizing screws, rivets, or other fasteners so that a protrusion 4 on the side of the clip meets and releasably interconnects with the side 12 of the cassette 13. Two spring clips are required for each cassette, one for each side. An exemplary cassette is disclosed in co-pending U.S. patent application Ser. No. 15/910,619 filed Mar. 2, 2018 and entitled “Uni-Body Design Fiber Optic Cassettes To Facilitate Rapid Deployment In Varied Configurations And Method To Produce Same” incorporated fully herein by reference.

In use, the spring clips 10 are in one of two states:

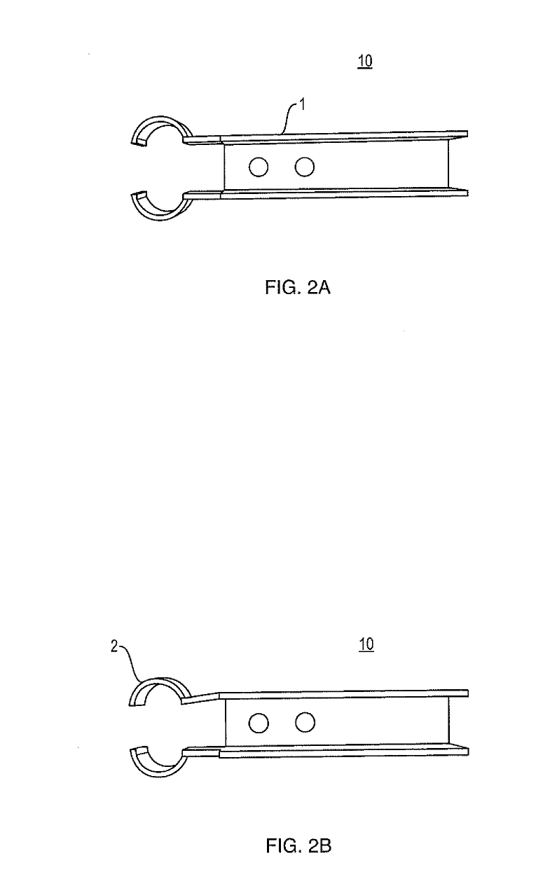

1. Disengaged (FIG. 2A); and

2. Engaged (FIG. 2B).

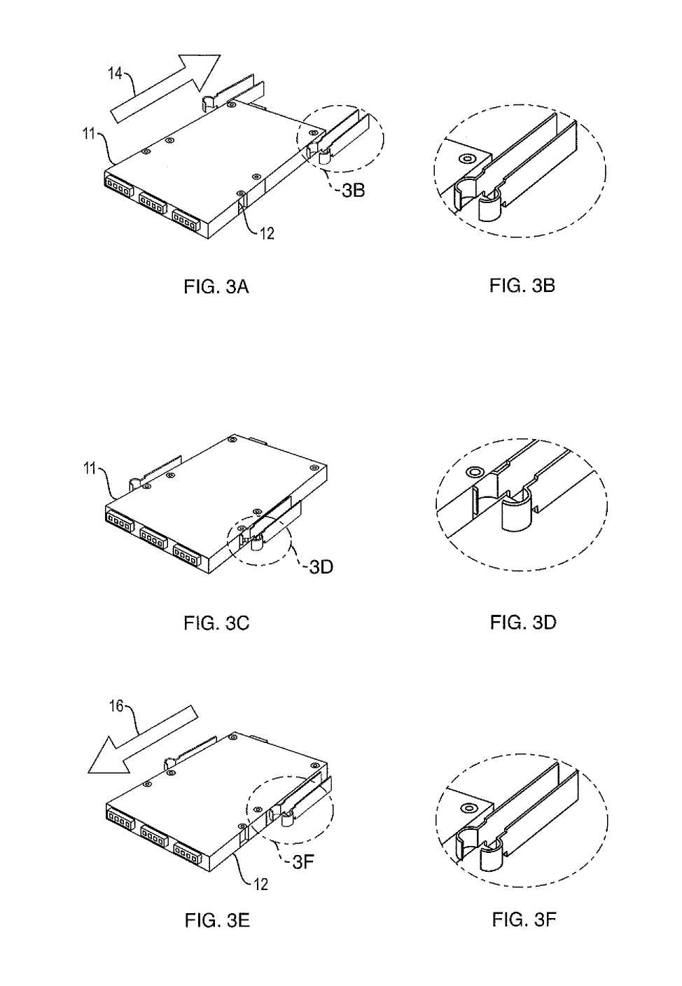

FIGS. 3A-3F illustrate the placement and interaction of the spring clips 10 on each side of a fiber optic cassette 11 that has been manufactured with a square or rectangular cavity 12. In use, the spring clip 10 according to the present invention is as follows:
1. Insertion. Push the cassette 11 inward in the direction indicated by arrow 14, FIG. 3A. The spring clips 10 begin in the disengaged state.
2. Secured. In use (standard operational state as shown in FIG. 3C), the spring clips 10 are in the engaged state engaged with the cassette.
3. Extraction. Pull the cassette outward as indicated by arrow 16, FIG. 3F. The spring clips 10 are again in the disengaged state (FIGS. 3B and 3F).

The present invention is not intended to be limited to a device or method which must satisfy one or more of any stated or implied objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the allowed claims.

1. A universal spring retainer unit configured for releasably securing a device to a surface, said universal spring retainer unit comprising:
a retainer device configured for being secured to a surface and including a first side and a second side, said second side being a mirror-image of said first side, said first and second sides each having a predetermined length, said second side coupled a spaced distance apart from said first side by a connector element which extends between said first and second side a length which is less than said predetermined length of said first and second sides, each of said first and second sides including a first end and a second end, said second end of each of said first and second sides of said retainer device including an arcuately shaped protrusion configured for releasably engaging with an opening in a device to be releasably secured to said surface.

2. The universal spring retainer unit according to claim 1, wherein said connector element includes one or more holes allowing said retainer device to be secured to said surface.

3. The universal spring retainer unit according to claim 1, wherein said retainer device is made of a spring metal.

4. The universal spring retainer unit according to claim 1, wherein said device to be releasably secured to said surface is a fiber-optic cassette.

5. The universal spring retainer unit according to claim 4, wherein said fiber-optic cassette includes an opening in first and second side portions of said fiber-optic cassette, said openings sized and configured to releasably interconnect with said arcuately shaped protrusions disposed proximate said second end of each of said first and second sides of said retainer device.
